(19) United States
(12) Patent Application Publication
(10) Pub. No.: US 2007/0072977 A1
(43) Pub. Date: Mar. 29, 2007

(54) Weather-resistant resin coating material and its manufacturing method

(75) Inventors: Hsien-Yi Chiu, Tu-Chen City (TW); Hung-Chang Chen, Tu-Chen City (TW)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Taiwan Textile Research Institute, Tu-Chen City (TW)

(21) Appl. No.: 11/312,700

(22) Filed: Dec. 20, 2005

(30) Foreign Application Priority Data
Sep. 27, 2005 (TW) 94133593

(51) Int. Cl. C08K 3/26

(52) U.S. Cl. 524/425; 524/431; 524/432

(57) ABSTRACT

A composition of a weather-resistant resin coating material is provided that comprises polyvinyl alcohol, metal oxide nanoparticles, a salt, a cross-linking agent and water. A manufacturing method of a weather-resistant resin coating material is also provided. First, a solution of polyvinyl alcohol and a solution of metal oxide nanoparticles are prepared. Then, these two solutions are mixed to form a mixture solution. A salt and a cross-link agent are added in the mixture solution. Finally, the mixture solution is stirred to form the weather-resistant resin coating material.

### RELATED APPLICATIONS

The present application is based on, and claims priority from, Taiwan Application Serial Number 94133593, filed Sep. 27, 2005, the disclosure of which is hereby incorporated by reference herein in its entirety.

### BACKGROUND

1. Field of Invention

The present invention relates to a coating material and its manufacturing method. More particularly, the present invention relates to a weather-resistant resin coating material and its manufacturing method.

2. Description of Related Art

Outdoor fabrics have been widely applied to a diverse spectrum of products. These products include outdoor commercial billboards, personal UV-resistant beach parasols, water-resistant backpacks, canopies, architectural eaves and roofing. Therefore, the market for outdoor fabrics is very broad and there are many financial opportunities in it.

Unlike normal fabrics, outdoor fabrics need to resist harsher conditions. These outdoor fabrics need to keep their original material properties even after long exposure to intense sunlight and heavy rain. Therefore, the outdoor fabrics are required not only to be lighter and thinner like the normal fabric but also to be strong and tough to resist bad weather. Moreover, there are specific requirements corresponding to different product markets that outdoor fabric products need to meet. For example, commercial billboards need to maintain their bright color even after sunshine or rainfall. Parasols need to have high UV-resistance. Canopies need to be water-resistant, wind-resistant and easy to be clean.

Generally speaking, the way to enhance the weather resistance of an outdoor fabric is mainly to coat a layer of weather-resistant resin on a fabric. The fabric material is often nylon, polyester, glass fiber or aromatic polyamide. The weather-resistant resin coating material can be polyvinyl chloride (PVC), polytetrafluoroethylene (PTFE), silicone, polyvinylidene difluoride (PVDF), acrylic resin or acrylic fluoride resin. Moreover, some UV absorbents are added to these resins to enhance their resistance to UV light. The UV absorbents include organic benzene ring compounds and inorganic titanium oxide. Among the resins, PVC is cheapest but has some environmental problems. Silicone, PTFE and PVDF are more environmentally friendly and have better weather-resistant properties than PVC, but they are expensive. Acrylic-type resin has poor weather-resistance and its organic UV absorbent is easily released from its surface after long usage time, which whitens the resin and weakens the adhesion between the resin and the fabric.

### SUMMARY

It is therefore an aspect of the present invention is to provide a weather-resistive resin coating material and its manufacturing method. The weather-resistive resin coating material can protect a fabric and increase its weather-resistive properties. Moreover, the weather-resistive resin coating material is cheap and environmental friendly.

Another aspect of the present invention is to provide a weather-resistant resin coating material and its manufacturing method that, when coated onto a fabric, causes the fabric to be very tough and water-resistant.

In accordance with the foregoing aspects, one embodiment of the present invention provides a weather-resistant resin coating material comprising polyvinyl alcohol, metal oxide nanoparticles, a salt, a cross-linking agent and water. An amount of the polyvinyl alcohol in the coating material is about 5˜40 wt %. The metal oxide nanoparticles are silicon oxide, titanium oxide, zirconium oxide, calcium carbonate, zinc oxide or a mixture thereof. The salt is sodium chloride, magnesium chloride, calcium chloride or a mixture thereof. The salt is used to increase the compatibility between the polyvinyl alcohol and the metal oxide nanoparticles. The cross-linking agent is NCO cross-linking agent and is used to enhance the hydrolysis-resistance of the polyvinyl alcohol resin.

In accordance with the foregoing aspects, one embodiment of the present invention provides a manufacturing method of a weather-resistant resin coating material. First, a solution of polyvinyl alcohol and a solution of metal oxide nanoparticles are prepared. Then, these two solutions are mixed to form a mixture solution. A salt and a cross-link agent are added in the mixture solution. Finally, the mixture solution is stirred to form the weather-resistant resin coating material Polyvinyl alcohol is cheap and environmentally friendly when used as the weather-resistant resin coating material. Moreover, the metal oxide nanoparticles in the coating material can increase weather-resistant properties of fabrics. The salt can increase compatibility between the polyvinyl alcohol and metal oxide nanoparticles. The cross-link agent can help cross-linking between polyvinyl alcohol molecules and thus can increase the hydrolysis-resistance of the polyvinyl alcohol.

### DETAILED DESCRIPTION OF THE PREFERRED EMBODIMENTS

In the invention, the composition of a weather-resistant resin coating material mainly comprises polyvinyl alcohol (PVA), metal oxide nanoparticles, a salt, a cross-linking agent and water. The amount of the PVA in the coating material is about 5˜40 wt %. The amount of the metal oxide nanoparticles in the PVA is about 1˜25 wt %. The amount of the salt in the PVA is about 5˜30 mole %. The amount of the cross-linking agent in the coating material is about 1˜10 mole %. The balance of the composition is water.

In the weather-resistant resin coating material, the molecular weight of the PVA is about 9000˜400000 and the alkalization ratio of the PVA is about 79˜99%.

The metal oxide nanoparticles in the coating material can enhance the toughness and weather-resistance of the coated fabric. The size of the metal oxide nanoparticles is about 1˜100 nm. In a preferred embodiment, the metal oxide nanoparticles are silicon oxide, titanium oxide, zirconium oxide, calcium carbonate, zinc oxide or a mixture thereof, more preferably silicon oxide.

The salt in the coating can enhance the compatibility between polyvinyl resin and metal oxide nanoparticles. The salt is metal salt. In a preferred embodiment, the salt is sodium chloride, magnesium chloride, calcium chloride or a mixture thereof, more preferably sodium chloride.

The cross-linking agent helps cross-linking between the PVA molecules and thus can increase the hydrolysis-resistance of the PVA. In a preferred embodiment, the cross-linking agent is NCO cross-linking agent. The NCO cross-linking is a type of compounds, which have two NCO functional groups at its both ends. These compounds utilize the two NCO functional groups to react separately with function groups on other two long chains of PVA molecules to form bonding. Therefore, two PVA molecules are connected together by the cross-linking agent.

In the beginning of manufacturing a weather-resistant resin coating material, a solution of PVA and a solution of metal oxide nanoparticles are prepared. Then, these two solutions are mixed by a high-speed shear cut dispersion machine to form a mixture solution. Salt and a cross-link agent are added in the mixture solution. Finally, the mixture solution is stirred by the high-speed shear cut dispersion machine. The high-speed shear cut dispersion machine can make metal nanoparticles homogeneously disperse in the solution of PVA.

TABLE 1
Weather-resistance comparison chart

| | Strength | | | | | |
|---|---|---|---|---|---|---|
| | (Kg/cm2 ) | | Toughness (%) | | Whiteness | |
| | Test | Test | Test | Test | Test | Test |
| | before | after | before | after | before | after |
| Blank fabric | 195 | 162 | 13 | 11 | 72 | 68 |
| | | (83%) | | (85%) | | (94%) |
| Fabric coated | 268 | 218 | 21 | 20 | 65 | 63 |
| with PVA | | (81%) | | (95%) | | (97%) |
| (containing | | | | | | |
| nanoparticles | | | | | | |
| and salt) | | | | | | |
| Fabric coated | 312 | 218 | 47 | 39 | 120 | 71 |
| with PVC | | (70%) | | (83%) | | (59%) |

Table 1 displays the test results according to ASTM-D2565 at 500 hours for blank fabric, fabric coated with the PVA and fabric coated with PVC. The test included exposing the fabrics to UV light to simulate outdoor sunshine and spraying water to simulate outdoor rainfall to measure changes in strength, toughness and whiteness after sunshine and rainfall. The blank fabric is an uncoated polyester fabric and is used to compare the other coated fabrics. The strength value is the maximum force that the fabric can bear without breaking. The toughness value is the maximum length that the fabric can stretch. The whiteness value was measured by comparing color of the fabrics with the color of a color plate. The higher the value is, the whiter the fabric is.

The molecular weight of the PVA of the coating material used was 118000. The alkalization ratio of the PVA was about 88% and the amount of PVA in the coating material was 10 wt %. The metal oxide nanoparticles were silicon oxide and were 15 wt % of PVA. The salt was sodium chloride and was 10 mole % in the PVA. The cross-linking agent was NCO cross-linking agent and was 2 wt % of the coating material.

Before doing the weather resistance test, the strength and the toughness of the fabric coated with the coating material containing PVA were better than those of the blank fabric. Even after the test, the strength and toughness of the fabric coated with the coating material containing PVA were still higher than those of the blank fabric.

Comparing the fabric coated with the coating material containing PVA with the fabric coated with PVC, 70% of the strength of the fabric coated with PVC was left after the test while 81% of the strength of the fabric coated with the coating material containing PVA was left after the test. The toughness of the fabric coated with PVC decreased significantly whereas the toughness of the fabric coated with the coating material containing PVA changed only slightly. Moreover, the whiteness of the fabric coated with PVC decreased rapidly after the test, which indicates that the fabric became yellow. On the contrary, the whiteness of the fabric coated with the coating material containing PVA remained the same, which indicates that the fabric had no apparent change to yellow.

Accordingly, the present invention has the following advantages.

(1) The resin used in the invention is PVA, which is cheap and environmentally friendly.

(2) The weather-resistant coating material of the invention can improve strength and toughness of fabrics greatly.

(3) The fabrics coated with the coating material containing PVA can retain their strength, toughness and color in harsh outdoor environments.

The preferred embodiments of the present invention described above should not be regarded as limitations to the present invention. It will be apparent to those skilled in the art that various modifications and variations can be made to the present invention without departing from the scope or spirit of the invention. The scope of the present invention is as defined in the appended claims.

What is claimed is:

1. A composition of a weather-resistant resin, comprising:
polyvinyl alcohol;
metal oxide nanoparticles;
a salt;
a cross-linking agent; and
water.

2. The composition of a weather-resistant resin of claim 1, wherein an amount of the polyvinyl alcohol in the coating material is about 5˜40 wt %.

3. The composition of a weather-resistant resin of claim 1, wherein a molecular weight of the polyvinyl alcohol is about 9000˜400000.

4. The composition of a weather-resistant resin of claim 1, wherein the alkalization ratio of the polyvinyl alcohol is about 79˜99%.

5. The composition of a weather-resistant resin of claim 1, wherein an amount of the metal oxide nanoparticles in the polyvinyl alcohol is about 1˜25 wt %.

6. The composition of a weather-resistant resin of claim 1, wherein the metal oxide nanoparticles are silicon oxide, titanium oxide, zirconium oxide, calcium carbonate, zinc oxide or a mixture thereof.

7. The composition of a weather-resistant resin of claim 1, wherein the metal oxide nanoparticles are silicon oxide.

8. The composition of a weather-resistant resin of claim 1, wherein a size of the metal oxide nanoparticles is about 1˜100 nm.

9. The composition of a weather-resistant resin of claim 1, wherein an amount of the salt in the polyvinyl alcohol is about 5˜30 mole %.

10. The composition of a weather-resistant resin of claim 1, wherein the salt is a metal salt.

11. The composition of a weather-resistant resin of claim 1, wherein the salt is sodium chloride, magnesium chloride, calcium chloride or a mixture thereof.

12. The composition of a weather-resistant resin of claim 1, wherein the salt is sodium chloride.

13. The composition of a weather-resistant resin of claim 1, wherein an amount of the cross-linking agent in the coating material is about 1˜10 wt %.

14. The composition of a weather-resistant resin of claim 1, wherein the cross-linking agent is NCO cross-linking agent.

15. A manufacturing method of a weather-resistant resin coating material, comprising:
preparing a solution of polyvinyl alcohol and a solution of metal oxide nanoparticles;
mixing the solution of polyvinyl alcohol and the solution of metal oxide nanoparticles to form a mixture solution;
adding a salt to the mixture solution;
adding a cross-link agent to the mixture solution; and
stirring the mixture solution.

16. The manufacturing method of a weather-resistant resin coating material of claim 15, wherein a size of the metal oxide nanoparticles is about 1˜100 nm.

17. The manufacturing method of a weather-resistant resin coating material of claim 15, wherein the metal oxide nanoparticles are silicon oxide, titanium oxide, zirconium oxide, calcium carbonate, zinc oxide or a mixture thereof.

18. The manufacturing method of a weather-resistant resin coating material of claim 15, wherein the salt is sodium chloride, magnesium chloride, calcium chloride or a mixture thereof.

19. The manufacturing method of a weather-resistant resin coating material of claim 15, wherein the cross-linking agent is NCO cross-linking agent.

20. The manufacturing method of a weather-resistant resin coating material of claim 15, wherein the steps of mixing or stirring are done by a high-speed shear cut dispersion method.
